(19) United States
(12) Patent Application Publication
(10) Pub. No.: US 2007/0133209 A1
(43) Pub. Date: Jun. 14, 2007

(54) Electrical lamp apparatus

(75) Inventors: Bily Wang, Hsin Chu (TW); Jonnie Chuang, Hsin Chu (TW); Shih-Yu Wu, Hsin Chu (TW)

Correspondence Address: HDSL, 4331 STEVENS BATTLE LANE, FAIRFAX, VA, 22033, US

(73) Assignee: Harvatek Corporation

(21) Appl. No.: 11/297,403

(22) Filed: Dec. 9, 2005

(51) Int. Cl. F21V 29/00; F21V 5/00

(52) U.S. Cl. 362/294; 362/326

(57) ABSTRACT

An electrical lamp apparatus includes a shade, a light-emitting unit and a light-focusing unit. After a power plug on the shade is connected to a power socket of the electrical lamp apparatus, the power plug supplies electrical power to light the light-emitting unit. The light from the light-emitting unit passes to a convex lens through a second channel of a second end face of the light-focusing unit, and then the light is projected through a first channel of the first end face of the light-focusing unit, whereby the light can be projected to a farther place.

### BACKGROUND OF THE INVENTION

1. Field of the Invention

The present invention relates to an electrical lamp apparatus, especially to an electrical lamp apparatus using light focusing unit to converge the light of the electrical lamp apparatus to a remote place.

2. Description of Prior Art

The prior art halogen lamp generally comprises a metal shade accommodating a lamp cup, a reflecting layer on inner wall of the lamp cup, and a halogen light bulb in the lamp cup. When the halogen light bulb is lighted, the reflecting layer on inner wall of the lamp cup reflects the light from the halogen light bulb to enhance efficiency and to provide local illumination.

In above-mentioned halogen lamp, the reflection of light relies on the reflecting layer on inner wall of the lamp cup. However, the emitted light is diffused from the halogen light bulb and is not concentrated. Therefore, the light cannot illuminate a remote place.

Moreover, the halogen lamp also has the drawbacks of high power consumptions, liable to damage and insufficient lifetime.

### SUMMARY OF THE INVENTION

It is an object of the present invention to provide an electrical lamp apparatus with light focusing ability to converge the light of the electrical lamp apparatus to a remote place

Accordingly, the present invention provides an electrical lamp apparatus, comprising:

a shade comprising a mounting section at one end and having at least one retaining hole, and comprising a power plug at another end thereof;

a light-emitting unit mounted on the mounting section and comprising a heat-dissipating plate within the shade and a light-emitting element arranged on the heat-dissipating plate, the light-emitting element comprising a conductive end electrically connected to one of controller circuit and rectifying circuit in the power plug; and

a light focusing unit arranged in the shade and in front of the light-emitting element, the light focusing unit comprising a first end face and a second end face corresponding to the light-emitting element, the first end face being tapered toward to the second end face, a first channel and a second channel being provided between the first end face and the second end face, a convex lens provided between the first channel and the second channel to focus a light emitted from the light-emitting element.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows an exploded view of the present invention.

FIG. 2 shows a perspective view of the present invention.

FIG. 3 shows a section view of the present invention.

FIG. 4 is a section view showing the application of the present invention.

### DETAILED DESCRIPTION OF THE INVENTION

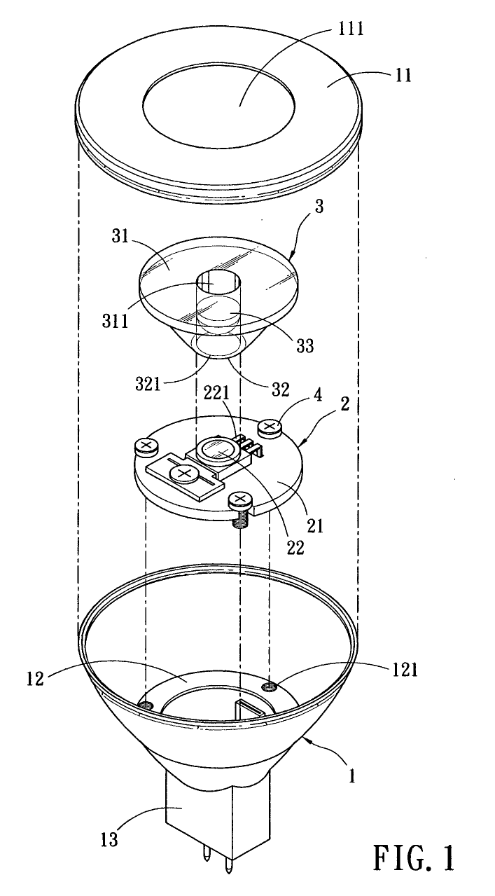

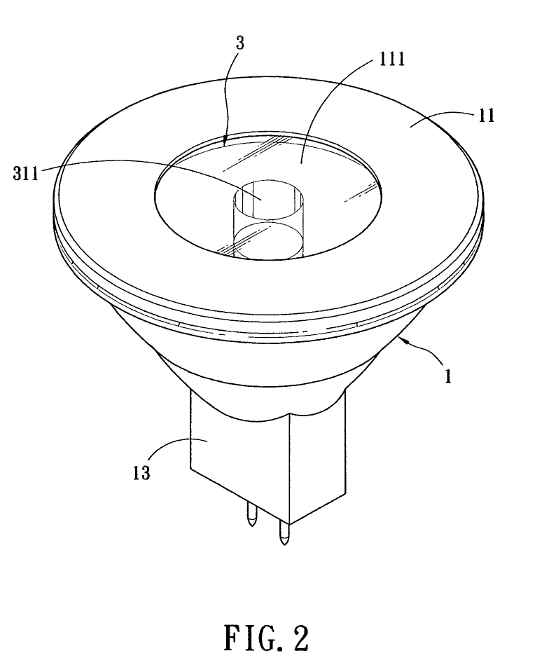

With reference to FIGS. 1 to 3, the electrical lamp apparatus of the present invention comprises a shade 1, a light emitting unit 2 and a focusing unit 3 to form lamp similar to a halogen light bulb for the halogen lamp.

The shade 1 is made of metal material and comprises, on one end thereof, a cover 11 with a through hole 111. The shade 1 comprises a mounting section 12 with at least one retaining hole 121. A power plug 13 is provided on one side of the shade 11.

The light-emitting unit 2 comprises a heat-dissipating plate 21 made of aluminum and assembled through fixing element 4 and the retaining hole 121. A light-emitting element 22 is arranged on the heat-dissipating plate 21 and is a light-emitting diode. The light-emitting element 22 comprises a conductive end 221 connected to one of a control circuit in the power plug 13 or a rectifying circuit (not shown).

The focusing unit 3 is arranged in the shade 1 and assembled with the light-emitting element 22. The focusing unit 3 comprises a first end face 31 corresponding to the through hole 111 and a second end face 32 corresponding to the light-emitting element 22. The first end face 31 is tapered toward the second end face 32. A first channel 311 and a second channel 321 are provided between the first end face 31 and the second end face 32 and a convex lens 33 is formed between the first channel 311 and the second channel 321. Therefore, the light emitted by the light-emitting element 22 can be focused by the focusing unit 3 and the convex lens 33 to project to a remote place.

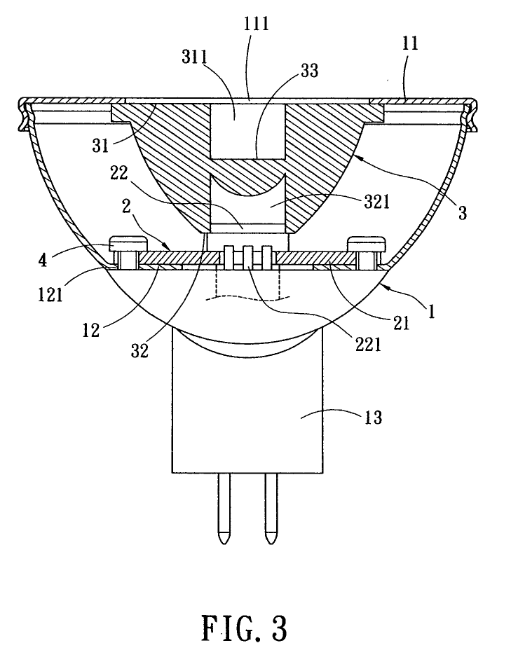

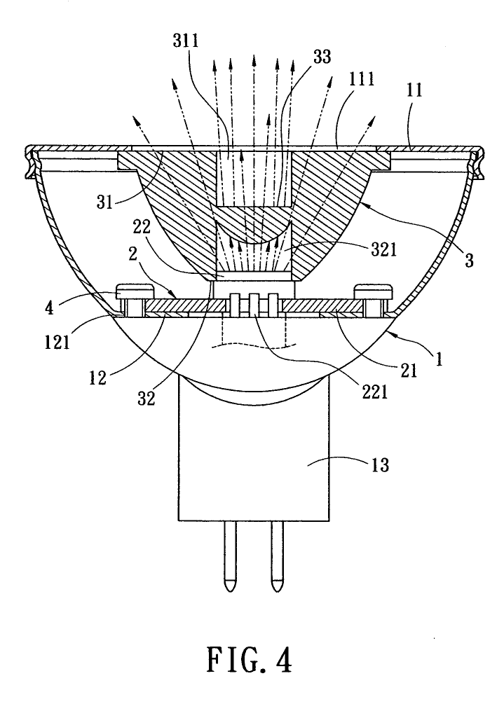

With reference to FIGS. 3 and 4, when the electrical lamp apparatus of the present invention is used, the power plug 13 is directly inserted to a power socket (not shown) for the electrical lamp apparatus. Therefore, the power plug 13 rectifies and stabilizes the power source to light the light-emitting element 22. The light emitted form the light-emitting element 22 enters the convex lens 33 through the second channel 321 and is focused by the convex lens 33. The focused light is projected through the first channel 311 to project to a remote place.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. An electrical lamp apparatus, comprising
a shade;
a light-emitting unit comprising a heat-dissipating plate within the shade and a light-emitting element arranged on the heat-dissipating plate; and
a light focusing unit arranged in the shade and in front of the light-emitting element, the light focusing unit comprising a first end face and a second end face corresponding to the light-emitting element, the first end face being tapered toward to the second end face, a first channel and a second channel being provided between the first end face and the second end face, a convex lens provided between the first channel and the second channel to focus a light emitted from the light-emitting element.

2. The electrical lamp apparatus as in claim 1, wherein the shade is made of metal material and comprises a power plug at one end thereof and a cover at another end thereof and a through hole being defined on the cover.

3. The electrical lamp apparatus as in claim 1, wherein the shade comprises a mounting section with at least one retaining hole.

4. The electrical lamp apparatus as in claim 2, wherein the power plug accommodates one of a controller circuit and a rectifying circuit.

5. The electrical lamp apparatus as in claim 1, wherein the heat-dissipating plate is made of aluminum.

6. The electrical lamp apparatus as in claim 5, wherein the heat-dissipating plate comprises a fixing element for fixing with the mounting section.

7. The electrical lamp apparatus as in claim 1, wherein the light-emitting element is a light-emitting diode.

8. The electrical lamp apparatus as in claim 1, wherein the light-emitting element comprises a conductive end connected to a controller circuit in a power plug.

9. The electrical lamp apparatus as in claim 1, wherein the light-emitting element comprises a conductive end connected to a rectifying circuit in a power plug.
